(19) United States
(12) Patent Application Publication
(10) Pub. No.: US 2026/0065578 A1
(43) Pub. Date: Mar. 5, 2026

(54) COMPOSITIONAL 3D-CONSISTENT FREEVIEW IMAGE GENERATION WITH 3D BLOBS

(71) Applicant: NVIDIA Corporation, Santa Clara, CA (US)

(72) Inventors: Chao Liu, Santa Clara, CA (US); Weili Nie, Sunnyvale, CA (US); Sifei Liu, San Diego, CA (US); Abhishek Haridas Badki, Goleta, CA (US); Hang Su, Hadley, MA (US); Morteza Mardani, Santa Clara, CA (US); Benjamin David Eckart, Oakland, CA (US); Arash Vahdat, San Mateo, CA (US)

(21) Appl. No.: 19/227,222

(22) Filed: Jun. 3, 2025

Related U.S. Application Data
(60) Provisional application No. 63/690,216, filed on Sep. 3, 2024.

(51) Int. Cl. G06T 15/20; G06T 5/50; G06T 5/60; G06T 5/77; G06T 7/55; G06T 7/80; G06V 10/764; G06V 10/82; G06V 20/20

(52) U.S. Cl. CPC G06T 15/20; G06T 5/50; G06T 5/60; G06T 5/77; G06T 7/55; G06T 7/80; G06T 2207/10016; G06T 2207/10024; G06T 2207/20081; G06T 2207/20084; G06V 10/764; G06V 10/82; G06V 20/20

(57) ABSTRACT

Diffusion models trained on largescale internet datasets have demonstrated an exceptional ability to generate high-quality and photorealistic two-dimensional (2D) images across diverse styles and domains. Generating three-dimensional (3D) scenes, however, is much more challenging and much less explored due to the lack of training data and the presence of many objects that necessitates compositionality and consistency across different views and objects. The present disclosure uses 3D blobs to create a compositional 3D scene representation from which 2D views can be generated.

### RELATED APPLICATION(S)

This application claims the benefit of U.S. Provisional Application No. 63/690,216 (Attorney Docket No. NVIDP1412+/24-SC-0760US01), titled “COMPOSITIONAL 3D-CONSISTENT FREEVIEW IMAGE GENERATION WITH 3D BLOBS” and filed Sep. 3, 2024, the entire contents of which is incorporated herein by reference.

### TECHNICAL FIELD

The present disclosure relates to processes for creating image content.

### BACKGROUND

Image generation has witnessed remarkable advances in recent years, largely driven by the development of generative adversarial networks and denoising diffusion models. In particular, diffusion models trained on largescale internet datasets have demonstrated an exceptional ability to generate high-quality and photorealistic two-dimensional (2D) images across diverse styles and domains. Generating three-dimensional (3D) scenes, however, is much more challenging and much less explored due to the lack of training data and the presence of many objects that necessitates compositionality and consistency across different views and objects.

In some early solutions, 2D image diffusion models (e.g., stable diffusion) were adopted as a prior to generate 3D consistent multi-view images. These solutions have been successful in certain applications such as texture inpainting, 3D content generation, and image relighting. However, their scope is limited to simple 3D scenes (with few objects) and more importantly they lack semantic controllability, i.e., one cannot explicitly manipulate the semantic content, such as the object appearance, in a fine-grained manner.

More recent approaches mitigate this issue to some extent using scene-level text descriptions, which are often coarse, or large language models (LLMs) that generate per-view captions, which lack 3D consistency. Nonetheless, it still remains a challenge to generate 3D scenes with object-specific control, which is critical for composing several objects in a complex scene, or when editing scene objects.

There is thus a need for addressing these issues and/or other issues associated with the prior art. For example, there is a need to provide a compositional 3D scene representation using 3D blobs, from which 2D views can be generated while also enabling controllability in 3D space.

### SUMMARY

A method, computer readable medium, and system are disclosed for generating a 2D image of a scene from a scene representation comprised of 3D blobs. An input that includes one or more 3D blobs each representing an object in a scene and each having a corresponding text description of the object is processed using a diffusion model to generate 2D image of the scene. The 2D image of the scene is output.

### BRIEF DESCRIPTION OF THE DRAWINGS

FIG. 1 illustrates a method for generating a 2D image of a scene from a scene representation comprised of 3D blobs, in accordance with an embodiment.

FIG. 2 illustrates a system pipeline for 3D blob-grounded image generation, in accordance with an embodiment.

FIG. 3 illustrates an exemplary implementation of the system pipeline of FIG. 2, in accordance with an embodiment.

FIG. 4 illustrates a method for training a diffusion model to provide 3D blob-grounded image generation, in accordance with an embodiment.

FIG. 5 illustrate a system pipeline for generating a training dataset comprised of 3D blobs with captions, in accordance with an embodiment.

FIG. 6A illustrates inference and/or training logic, according to at least one embodiment;

FIG. 6B illustrates inference and/or training logic, according to at least one embodiment;

FIG. 7 illustrates training and deployment of a neural network, according to at least one embodiment;

FIG. 8 illustrates an example data center system, according to at least one embodiment.

### DETAILED DESCRIPTION

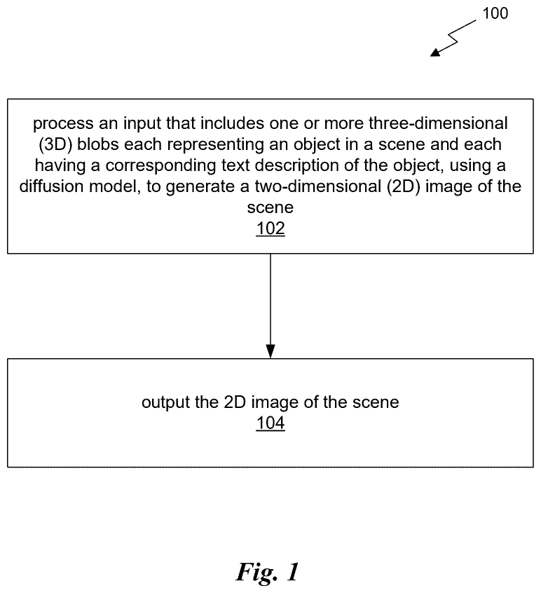

FIG. 1 illustrates a method 100 for generating a 2D image of a scene from a scene representation comprised of 3D blobs, in accordance with an embodiment. The method 100 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, an input that includes one or more 3D blobs each representing an object in a scene and each having a corresponding text description of the object is processed using a diffusion model to generate 2D image of the scene. The scene may be defined, at least in part, by the 3D blob(s) each representing an object in the scene. The object may be any 3D visual element in the scene.

With respect to the present description, a 3D blob refers to a data representation that defines, at least in part, spatial information for an object in a scene. Thus, in an embodiment, each of the one or more 3D blobs may define one or more parameters of the object represented by the 3D blob. For example, the one or more parameters may include a location of the object in the scene, a size of the object in the scene, an orientation of the object in the scene, etc. In an embodiment, the one or more 3D blobs included in the input may collectively represent a layout of the scene, such as more specifically the layout of one or more objects in the scene.

As mentioned, the input also includes, for each of the 3D blobs included in the input, a corresponding text description of the object represented by the 3D blob. In an embodiment, the text description of the object may be a caption for the 3D blob. In an embodiment, the text description of the object may be a text that describes an appearance of the object in the scene, such as a color, texture, etc. of the object. To this end, the 3D (i.e. object-level) blob(s) and corresponding text description(s) together may be considered visual primitives that represent a 3D scene.

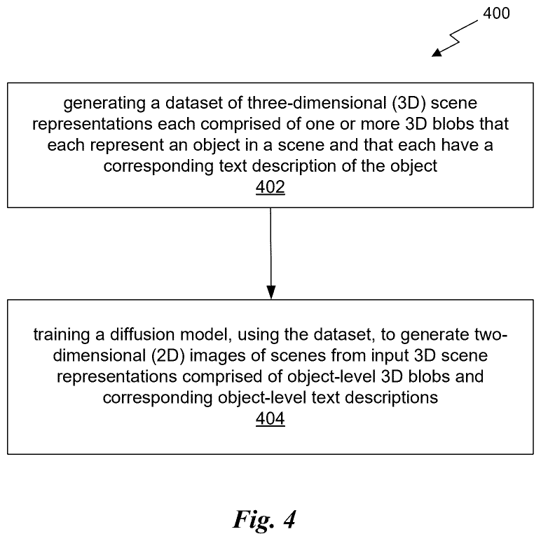

The input, which as described above includes the 3D blob(s) and corresponding text description(s), is processed using a diffusion model to generate a 2D image of the scene. In an embodiment, the input may be processed by the diffusion model, as described below, over multiple iterations to generate multiple different 2D images of the scene that are 3D consistent (i.e. that are consistent with the 3D scene). In an embodiment, the diffusion model may be a text-to-image generative diffusion model, which may be trained as described in more detail below with respect to FIG. 4.

In an embodiment, processing the input may include projecting the one or more 3D blobs into 2D to generate one or more 2D blobs each representing an object in the scene and having the corresponding text description of the object, and further processing the one or more 2D blobs with the corresponding text description, by the diffusion model, to generate the 2D image of the scene. In an embodiment, the 3D blobs may be projected into 2D based on a camera pose and one or more camera intrinsic parameters (e.g. focal length, aspect ratio, sensor resolution, etc.). Accordingly, the 2D image of the scene may correspond to a viewpoint of the scene from the camera pose.

In an embodiment, the diffusion model may process the one or more 2D blobs together with an input depth map, to generate the 2D image of the scene. In an embodiment, the diffusion model may process the one or more 2D blobs together with one or more other 2D images of the scene previously generated by the diffusion model from the one or more 2D blobs, to generate the 2D image of the scene. In an embodiment, the diffusion model may process the one or more 2D blobs together with all 2D images of the scene previously generated by the diffusion model from the one or more 2D blobs, to generate the 2D image of the scene.

In an embodiment, the processing may be repeated at least one additional time to generate at least one additional 2D image capturing a different viewpoint of the scene (e.g. based on a different given camera pose). Since the 2D images are generated from the 3D scene representation, and in an embodiment also from the prior generated 2D images, the 2D images may be consistent with respect to the 3D scene and thus with respect to each other.

In an embodiment, the text description of the object may guide a visual appearance of the object in the 2D image of the scene. As a result, in accordance with an embodiment, the visual appearance of the object in the 2D image may be customizable by modifying the text description of the object. For example, after modifying the text description of the object, the diffusion model may be used (per operation 102) to generate a new 2D image in accordance with the modified text description.

In operation 104, the 2D image of the scene is output. In an embodiment, the 2D image may be output to a memory. In an embodiment, the 2D image may be output (e.g. streamed) to a remote system. In an embodiment, the 2D image may be output to a downstream application, such as a video game, a virtual reality application, an augmented reality application, etc. In an embodiment, the method 100 may be performed online (e.g. in real-time) to support online applications such as the downstream applications mentioned above.

Further embodiments will now be provided in the description of the subsequent figures. It should be noted that the embodiments disclosed herein with reference to the method 100 of FIG. 1 may apply to and/or be used in combination with any of the embodiments of the remaining figures below.

Embodiments disclosed herein provide a compositional 3D scene representation that is decoupled from a 2D view generation process, which enables controllability directly in 3D space while fully leveraging the capabilities of 2D diffusion models. In embodiments, the scene representation may describe the appearance, location, size, and orientation of each object in the scene. In embodiments, to generate views, the 3D representation may be projected onto the 2D space to guide the 2D diffusion models. By keeping the scene representation in 3D, the model can take into account view dependencies such as camera pose, occlusion, and depth for all the objects in the scene. In addition, after projection, the rich generative prior of large-scale pretrained text-to-image diffusion models can be leveraged to effect photorealism. In embodiments, with the explicit object-level representation, objects can be manipulated individually by editing their respective text description directly in the 3D space.

As disclosed herein, (object-level) 3D blobs with text description may be used as visual primitives to represent the 3D scene. In contrast with text-based scene description, the object-level blobs may provide a compositional and compact representation of the scene layout, as well as the size and orientation of each object. Moreover, the text description may include the appearance data (per object), which is well-suited for conditioning text-to-image generative models. In the view generation phase, the 3D blobs may be projected onto 2D blobs that provide an extra layout information on top of the object-wise text descriptions. The text descriptions attached to 3D blobs can allow the object appearance (in all generated views) to be edited by a user simply editing the 3D object description.

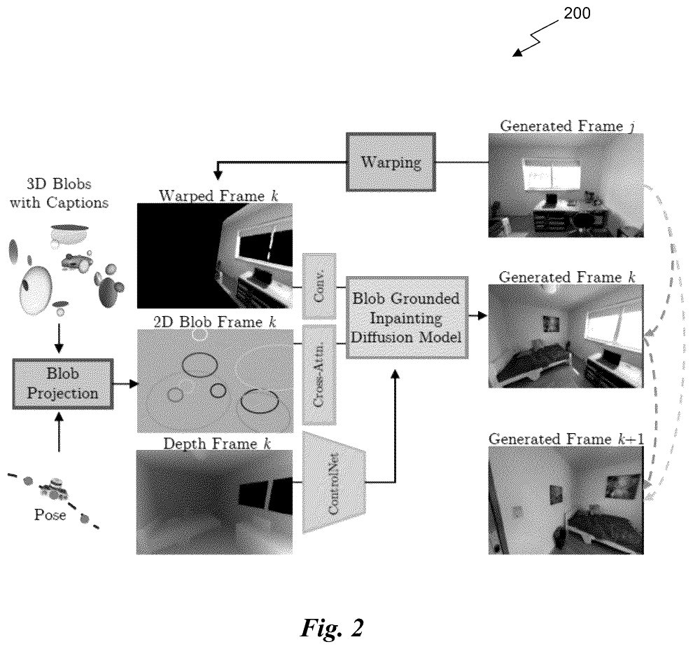

As described below with respect to FIG. 2, an online and autoregressive 3D-consistent freeview image sequence generation pipeline 200 may generate cross-view coherent images for a given 3D scene (as defined by the 3D blob scene representation) conditioned on camera poses and depth inputs. The online property of this pipeline 200 makes it useful for interactive applications such as gaming and virtual tours where the views are generated as the user traverses in the virtual 3D space. In addition, since the 3D scene representation is decoupled from the 2D image generation and can be easily converted to 2D input conditioning, a pretrained 2D-blob-grounded text-to-image diffusion model may be used as the backbone for the pipeline 200, taking advantage of the rich image generative priors learned from large-scale data.

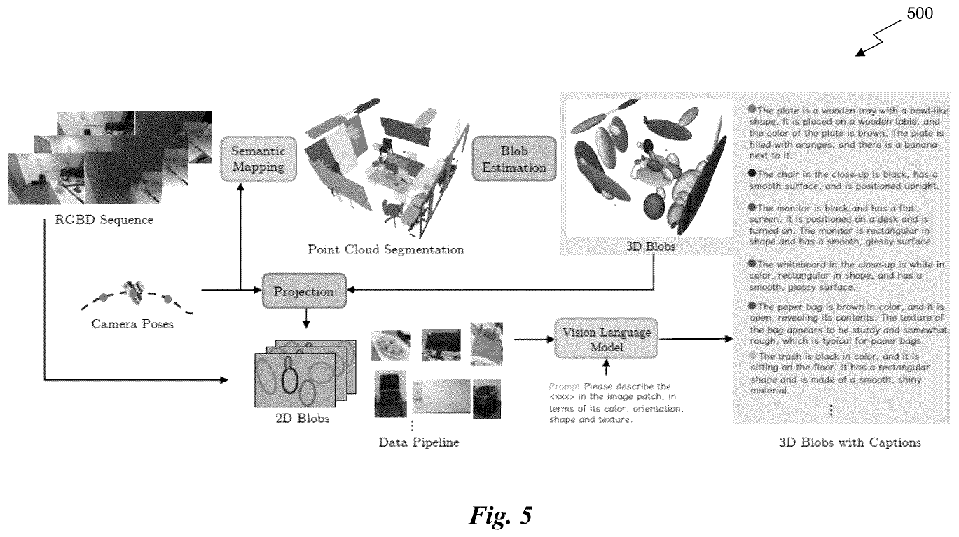

To repurpose the pretrained 2D generative model for 3D-consistent freeview image generation, a data curation pipeline, as described below with respect to FIG. 5, may be used to collect the proposed 3D scene representation from posed red, green, blue, depth (RGBD) image sequences, the collected data may be used to fine-tune a pretrained image generative model. Although the pipeline 200 may be online in some embodiments, in which case there is no access to future frames in the sequence, the pipeline 200 can still achieve the state-of-the-art performance on freeview image sequence generation, compared to existing offline multi-view or global optimization-based methods that use scene-level text descriptions or pre-captured 2D image captions. In addition, the embodiments described herein can enable on-the-fly object appearance editing.

Returning to FIG. 2, a system pipeline 200 for 3D blob-grounded image generation is illustrated, in accordance with an embodiment. The system pipeline 200 may be implemented to perform the method 100 of FIG. 1, in an embodiment. Of course, however, the system pipeline 200 may be implemented in any desired context. The definitions and embodiments described above may equally apply to the description of the present embodiment.

### Compositional 3D Scene Representation

In embodiments, for image generation conditioned on a 3D scene representation, three properties may be required: 1) compositional (e.g. and compact) representation of the 3D spatial layout; 2) direct editability for object-wise content modifications; 3) easy conversion to 2D image conditions used for pretrained 2D generative models. To achieve this, object-level 3D blobs with text descriptions are used as the scene primitives. The compact 3D blob parameterization provides the 3D spatial layout of the scene, as well as the size and orientation of each object; while the text descriptions provide the semantic and appearance information for each object and can be easily consumed by a pretrained 2D generative model. In addition, projecting 3D blobs onto the image plane given the camera pose offers view-dependent 2D object layout information, alongside the text descriptions.

Compared to other simple 3D primitives like cubes, a key property of the 3D blob is that its representation remains consistent under projection: the projection of a 3D blob onto the image plane results in a 2D blob that can be parameterized similarly. This allows a 3D blob to be easily converted to a 2D blob, which can be directly used as the input for the 2D blob-grounded image generative model. The rich generative prior learned from large-scale image data can therefore be leveraged while maintaining 3D control. In contrast, under projection, other 3D primitives like 3D cubes will be distorted into 2D shapes that are hard to parameterize, making it hard for the model to use the layout and shape conditions.

More specifically, system pipeline 200 uses a geometrical parameterization where: the location, orientation and scale of each 3D blob is parameterized by a 9D vector τ:=(μ, l, q), where μ∈ [symbol] is the 3D location of the blob center, l∈ [symbol] is the lengths of the blob along the three axes, and q∈ [symbol] is the unit quaternion representing the orientation of the blob. The description of one blob is defined as s:=(s₁, . . . , s_{M}), where M represents the length of the sentence. The 3D scene is a collection of N blobs, S:={τᵢ, sᵢ|i=1, . . . , N}. The 3D blob representation does not necessarily require parameters for color, opacity, spherical harmonics, or other appearance information, since the appearance information is conveyed through text descriptions. Given a queried view indexed by k with camera pose T^{k}, each 3D blob is projected onto the image plane independently per Equation 1.

$${τ}_{i}^{k} = r ( {τ}_{i} ; {T}^{k} ) \qquad Equation l$$

Note that in this simplified blob projection, the mutual occlusions between 3D blobs are not explicitly modeled and so an occupancy parameter is also not used, in the present embodiment. The view-dependent 2D blob depth ordering can be either learned from data from the generative model, or complemented by the input depth map condition to the model as shown in the present embodiment. For each queried view k, the 2D image blob condition is a set of blobs denoted as

$${C}^{k} := \{ {τ}_{j}^{k} , {s}_{j} \vert j ∈ {V}^{k} \} ,$$

with V^{k} the set of indices of visible blobs.

### Freeview Generation as Conditional Inpainting

The online freeview image generation is formulated as an (autoregressive inpainting task. The pretrained model is extended to the 3D blob-grounded image generation task by conditioning on not only the 2D blobs, but also the depth map and the partial novel view synthesis (NVS) image estimated by warping previously generated views. The projected 2D blobs from the 3D scene representation provide object-wise semantic layout and appearance information for the inpainting task, while the depth map and the partial NVS image provide the fine-grained geometric conditions such as occlusion, and context information from previous views for inpainting.

More specifically, at each diffusion step t, the denoising model takes as input the 2D blob condition C^{k}, the depth map d^{k}, the partial NVS image Î^{k} and the noisy latent image xₜ to predict the time-resolved noise \hat{∈}ₜ, which is used to compute the denoised latent image xₜ₋₁ iteratively, per Equation 2.

$${\hat{ϵ}}_{t} = {ϵ}_{Θ} ( {x}_{t} , t ; {C}^{k} , {d}^{k} , {\hat{I}}^{k} , {m}^{k} ) ) \qquad Equation 2$$

where d^{k} is the input depth map; m^{k}={0, 1} is an inpainting mask indicating the visible regions from the source views during NVS and ∈_{Θ} is the denoising model.

To utilize the rich image generative prior learned from large-scale dataset, the conditional inpainting model is built by extending a pretrained blob-ground text-to-image diffusion model (e.g. BlobGEN). The extension consists of two parts: 1) adding the depth map and the partial NVS image as additional input conditions to the model; 2) fine-tuning the pretrained model on the 3D blob-grounded image generation task. As shown, the depth map condition is encoded by a separate ControlNet branch, and further the NVS image condition and the mask conditions are directly concatenated with the noisy latent image. The projected 2D blob conditions and object text descriptions are encoded with masked cross attention layers to guide the inpainting process.

The partial NVS image is estimated by warping the source images to the target view using the target view depth map and relative camera poses between the source and target views. To avoid stitching and blurring artifacts, the contribution of the source views that are far from the target view are suppressed. In an embodiment, all but the top-3 closest source views to the target view may be zero-suppressed. Other weighting mechanisms may also be used for the source views, such as depth maps and grazing angles.

To this end, the system pipeline 200, as described above, is an auto-regressive image generation pipeline in which a 2D diffusion model takes the projected blobs, depth map and warped image from previous generated frames as inputs. The projected 3D blobs with captions provide compositional semantic, appearance and view-dependent 2D layout information for the diffusion model. The input depth map and warped image complement details for consistent generation. For multi-view consistency, multiple frames are used to composite the warped image.

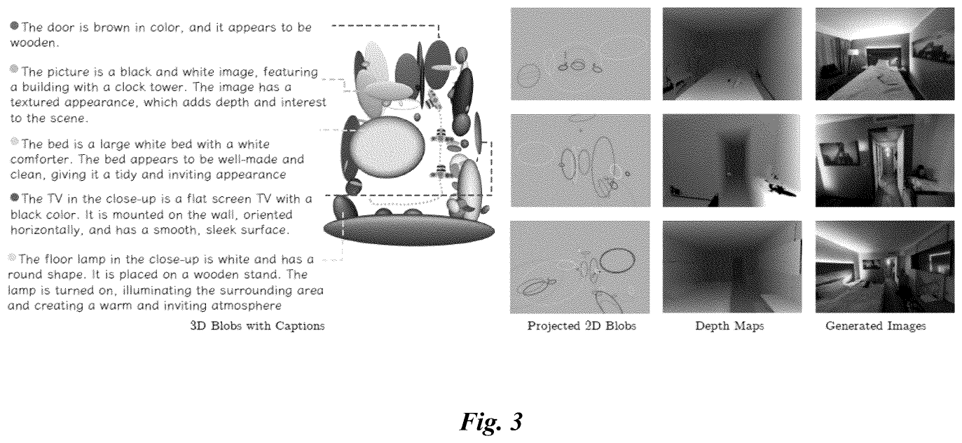

FIG. 3 illustrates an exemplary implementation of the system pipeline 200 of FIG. 2, in accordance with an embodiment.

As shown, the 3D objects are represented as blobs with specific orientation, size, shape and text descriptions. In the image generation phase, a diffusion model is conditioned on the corresponding 2D projected blobs as well as the input depth images to generate 3D consistent freeview images.

FIG. 4 illustrates a method 400 for training a diffusion model to provide 3D blob-grounded image generation, in accordance with an embodiment. The diffusion model may be the model used in the method 100 of FIG. 1 and/or included in the system pipeline 200 of FIG. 2. Thus, the definitions and embodiments described above may equally apply to the description of the present embodiment.

In operation 402, a dataset of 3D scene representations is generated, with each 3D scene representation comprised of one or more 3D blobs that each represent an object in a scene and that each have a corresponding text description of the object. In an embodiment, generating the dataset of 3D scene representations may include generating each of the 3D scene representations from a respective sequence of posed images. In an embodiment, the posed images may include color information and depth information. In an embodiment, the posed images may be four-channel (e.g. RGBD) images.

In an embodiment, generating the dataset of 3D scene representations may include, for each of the 3D scene representations, semantically mapping the posed images to obtain a 3D point cloud segmentation. In an embodiment, the semantic mapping may include unprojecting open-vocabulary 2D image segmentations into 3D.

In an embodiment, generating the dataset of 3D scene representations may include, for each of the 3D scene representations, generating the one or more 3D blobs from the 3D point cloud segmentation. In an embodiment, the one or more 3D blobs may be generated from the 3D point cloud segmentation by applying spectral clustering on a distance matrix of the 3D point cloud segmentation to fuse segmentations into the one or more 3D blobs. In an embodiment, the distance matrix may include distances that are each a weighted combination of geometric distance and semantic distance in a Contrastive Language-Image Pre-Training (CLIP) model.

In an embodiment, generating the dataset of 3D scene representations may include, for each of the 3D scene representations, generating the text description for each of the one or more 3D blobs. In an embodiment, the text description for each of the one or more 3D blobs may be generated by projecting the 3D blob onto a plurality of posed 2D views to obtain a plurality of object masks, selecting one of the posed 2D views resulting in one of the plurality of object masks having a largest mask area, and processing the selected posed 2D view, by a vision-language model, to generate the text description for the 3D blob.

In operation 404, a diffusion model is trained, using the dataset, to training a diffusion model, using the dataset, to generate 2D images of scenes from input 3D scene representations comprised of object-level 3D blobs and corresponding object-level text descriptions. In an embodiment, training the diffusion model, using the dataset, may include, in a first training stage fine-tuning attention layers for 2D blob guidance from a pretrained blob-grounded text-to-image diffusion model, and then in a second training stage configuring a first convolutional layer of the fine-tuned diffusion model to take as conditioning input both inpainting and one or more prior generated and scene-specific 2D images, adding to the fine-tuned diffusion model an additional network for accepting depth map guidance, and training the first convolutional layer and the control layer with the attention layers fine-tuned in the first training stage. In an embodiment, a control backbone of the pretrained blob-grounded text-to-image diffusion model may be frozen during the first training stage and the second training stage.

In an embodiment, each of the 3D scene representations may be generated from a respective sequence of posed images, and the diffusion model may be trained on pairs of images from the sequence of posed images. In an embodiment, the diffusion model may be trained on the pairs of images from the sequence of posed images, including: given a queried image from the sequence of posed images, randomly sample a source image from the sequence of posed images that has overlapping regions with the queried image, using the source image to obtain prior images from the sequence of posed images and an inpainting mask, and computing a loss between predicted and ground truth noise over a data distribution, where the loss is computed as a function of the prior images and the inpainting mask.

In an embodiment, the method 400 may further include deploying the trained diffusion model for use by a downstream application to generate the 2D images. The diffusion model may be used in accordance with the method 100 of FIG. 1, in an embodiment.

### Exemplary Training Procedure

The goal of the training is to repurpose a pretrained blob-ground text-to-image diffusion model (e.g. BlobGEN) for 3D blob-grounded image generation. The training consists of two stages. In the first stage, the attention layers for the 2D blob guidance are fine-tuned from the pretrained model. In the second stage, the first convolutional layer of the UNet is modified to take the concatenated NVS image and inpainting as conditioning input; in the meanwhile, the ControlNet is added for the depth map guidance. The additional layers are trained along with the attention layers fine-tuned in the first stage. For both stages, the UNet backbone of the pretrained model is frozen to retain the generative prior.

The model is trained on pairs of images from a training frame sequence. The training frame sequence may be generated per the system pipeline 500 of FIG. 5 described below. For the training, given a queried frame, a source frame having overlapping regions with the queried frame is randomly sampled, and the source frame is used to get the NVS image and inpainting mask. The loss function is the expectation of the L2 distance between the predicted and ground-truth noise over the data distribution, per Equation 3.

$$ℒ = {𝔼}_{x ∼ {p}_{train} , ϵ ∼ N ( 0 , 1 ) , t ∼ U [ 0 , 1 ]} [ {‖ ϵ - {ϵ}_{Θ} ( {x}_{t} , t ; {C}^{k} , {d}^{k} , {\hat{I}}^{k} , {m}^{k} ) ‖}_{2}^{2} ] \qquad Equation 3$$

with Î^{k}(p), d^{k}(p), m^{k}(p) being the partial NVS image, depth map, and inpainting mask respectively.

FIG. 5 illustrate a system pipeline 500 for generating a training dataset comprised of 3D blobs with captions, in accordance with an embodiment. The training dataset may be generated to train the model per the method 400 of FIG. 4.

To train the diffusion model for 3D blob-grounded image generation, a dataset of posed RGB-D sequences paired with corresponding 3D scene blobs is needed. The system pipeline 500 of FIG. 5 begins with semantic mapping of RGB-D sequences to obtain 3D point cloud segmentation. This involves unprojecting open-vocabulary 2D image segmentations into 3D. To address inconsistencies in per-frame segmentation, spectral clustering on the point cloud's distance matrix is applied to fuse segmentations into consistent object-level 3D blobs. The distance is a weighted combination of geometric distance and semantic distance in CLIP feature embedding.

After obtaining the 3D point cloud segmentation, the blob parameters {τᵢ|i=0, . . . , N} are fitted. For text descriptions, the 3D blobs are projected onto posed 2D views to get object masks. For each 3D object, the view with the largest mask area is selected as the key view. Using a vision-language model (VLM), text descriptions {sᵢ|i=0, . . . , N} are generated for the blobs. The system pipeline 500 is fully automatic, scalable to large datasets, and requires no additional model training or global optimization.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

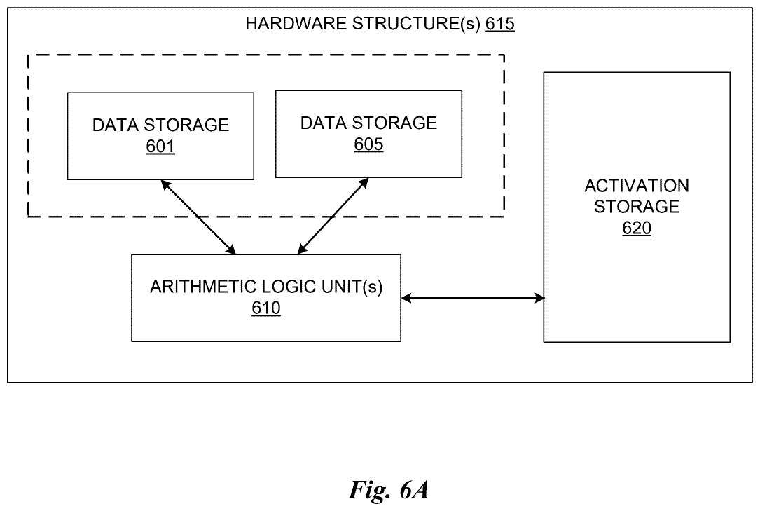

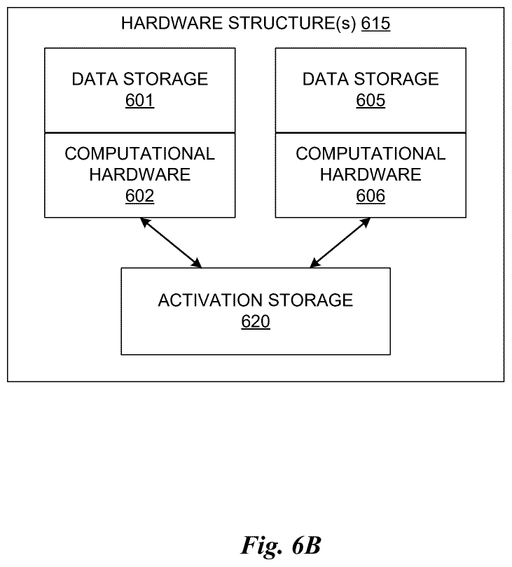

As noted above, a deep learning or neural learning system needs to be trained to generate inferences from input data. Details regarding inference and/or training logic 615 for a deep learning or neural learning system are provided below in conjunction with FIGS. 6A and/or 6B.

In at least one embodiment, inference and/or training logic 615 may include, without limitation, a data storage 601 to store forward and/or output weight and/or input/output data corresponding to neurons or layers of a neural network trained and/or used for inferencing in aspects of one or more embodiments. In at least one embodiment data storage 601 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 601 may be included with other on-chip or off-chip data storage, including a processor's L1, L2, or L3 cache or system memory.

In at least one embodiment, any portion of data storage 601 may be internal or external to one or more processors or other hardware logic devices or circuits. In at least one embodiment, data storage 601 may be cache memory, dynamic randomly addressable memory (“DRAM”), static randomly addressable memory (“SRAM”), non-volatile memory (e.g., Flash memory), or other storage. In at least one embodiment, choice of whether data storage 601 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 615 may include, without limitation, a data storage 605 to store backward and/or output weight and/or input/output data corresponding to neurons or layers of a neural network trained and/or used for inferencing in aspects of one or more embodiments. In at least one embodiment, data storage 605 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 605 may be included with other on-chip or off-chip data storage, including a processor's L1, L2, or L3 cache or system memory. In at least one embodiment, any portion of data storage 605 may be internal or external to on one or more processors or other hardware logic devices or circuits. In at least one embodiment, data storage 605 may be cache memory, DRAM, SRAM, non-volatile memory (e.g., Flash memory), or other storage. In at least one embodiment, choice of whether data storage 605 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 601 and data storage 605 may be separate storage structures. In at least one embodiment, data storage 601 and data storage 605 may be same storage structure. In at least one embodiment, data storage 601 and data storage 605 may be partially same storage structure and partially separate storage structures. In at least one embodiment, any portion of data storage 601 and data storage 605 may be included with other on-chip or off-chip data storage, including a processor's L1, L2, or L3 cache or system memory.

In at least one embodiment, inference and/or training logic 615 may include, without limitation, one or more arithmetic logic unit(s) (“ALU(s)”) 610 to perform logical and/or mathematical operations based, at least in part on, or indicated by, training and/or inference code, result of which may result in activations (e.g., output values from layers or neurons within a neural network) stored in an activation storage 620 that are functions of input/output and/or weight parameter data stored in data storage 601 and/or data storage 605. In at least one embodiment, activations stored in activation storage 620 are generated according to linear algebraic and or matrix-based mathematics performed by ALU(s) 610 in response to performing instructions or other code, wherein weight values stored in data storage 605 and/or data 601 are used as operands along with other values, such as bias values, gradient information, momentum values, or other parameters or hyperparameters, any or all of which may be stored in data storage 605 or data storage 601 or another storage on or off-chip. In at least one embodiment, ALU(s) 610 are included within one or more processors or other hardware logic devices or circuits, whereas in another embodiment, ALU(s) 610 may be external to a processor or other hardware logic device or circuit that uses them (e.g., a co-processor). In at least one embodiment, ALUs 610 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 601, data storage 605, and activation storage 620 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 620 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 620 may be cache memory, DRAM, SRAM, non-volatile memory (e.g., Flash memory), or other storage. In at least one embodiment, activation storage 620 may be completely or partially within or external to one or more processors or other logical circuits. In at least one embodiment, choice of whether activation storage 620 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 615 illustrated in FIG. 6A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6A may be used in conjunction with central processing unit (“CPU”) hardware, graphics processing unit (“GPU”) hardware or other hardware, such as field programmable gate arrays (“FPGAs”).

FIG. 6B illustrates inference and/or training logic 615, according to at least one embodiment. In at least one embodiment, inference and/or training logic 615 may include, without limitation, hardware logic in which computational resources are dedicated or otherwise exclusively used in conjunction with weight values or other information corresponding to one or more layers of neurons within a neural network. In at least one embodiment, inference and/or training logic 615 illustrated in FIG. 6B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6B may be used in conjunction with central processing unit (CPU) hardware, graphics processing unit (GPU) hardware or other hardware, such as field programmable gate arrays (FPGAs). In at least one embodiment, inference and/or training logic 615 includes, without limitation, data storage 601 and data storage 605, which may be used to store weight values and/or other information, including bias values, gradient information, momentum values, and/or other parameter or hyperparameter information. In at least one embodiment illustrated in FIG. 6B, each of data storage 601 and data storage 605 is associated with a dedicated computational resource, such as computational hardware 602 and computational hardware 606, respectively. In at least one embodiment, each of computational hardware 606 comprises one or more ALUs that perform mathematical functions, such as linear algebraic functions, only on information stored in data storage 601 and data storage 605, respectively, result of which is stored in activation storage 620.

In at least one embodiment, each of data storage 601 and 605 and corresponding computational hardware 602 and 606, respectively, correspond to different layers of a neural network, such that resulting activation from one “storage/computational pair 601/602” of data storage 601 and computational hardware 602 is provided as an input to next “storage/computational pair 605/606” of data storage 605 and computational hardware 606, in order to mirror conceptual organization of a neural network. In at least one embodiment, each of storage/computational pairs 601/602 and 605/606 may correspond to more than one neural network layer. In at least one embodiment, additional storage/computation pairs (not shown) subsequent to or in parallel with storage computation pairs 601/602 and 605/606 may be included in inference and/or training logic 615.

### Neural Network Training and Deployment

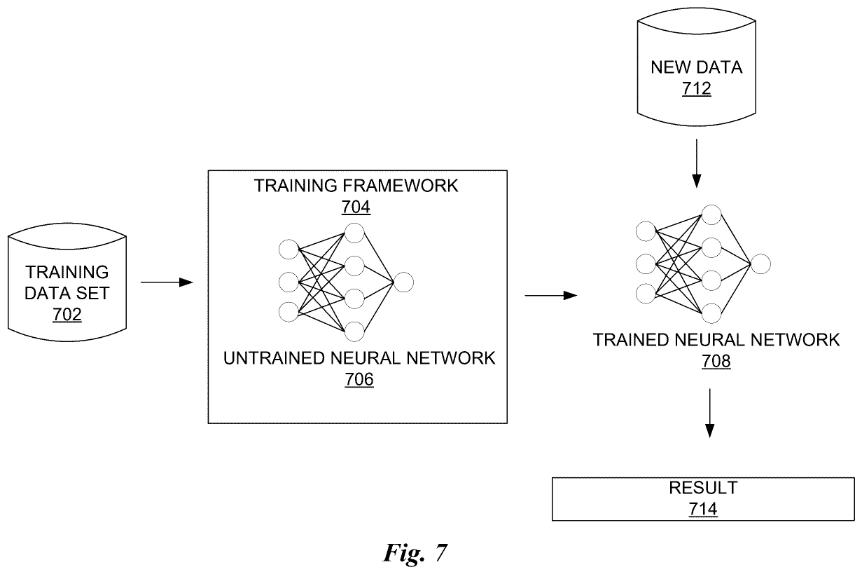

FIG. 7 illustrates another embodiment for training and deployment of a deep neural network. In at least one embodiment, untrained neural network 706 is trained using a training dataset 702. In at least one embodiment, training framework 704 is a PyTorch framework, whereas in other embodiments, training framework 704 is a Tensorflow, Boost, Caffe, Microsoft Cognitive Toolkit/CNTK, MXNet, Chainer, Keras, Deeplearning4j, or other training framework. In at least one embodiment training framework 704 trains an untrained neural network 706 and enables it to be trained using processing resources described herein to generate a trained neural network 708. In at least one embodiment, weights may be chosen randomly or by pre-training using a deep belief network. In at least one embodiment, training may be performed in either a supervised, partially supervised, or unsupervised manner.

In at least one embodiment, untrained neural network 706 is trained using supervised learning, wherein training dataset 702 includes an input paired with a desired output for an input, or where training dataset 702 includes input having known output and the output of the neural network is manually graded. In at least one embodiment, untrained neural network 706 is trained in a supervised manner processes inputs from training dataset 702 and compares resulting outputs against a set of expected or desired outputs. In at least one embodiment, errors are then propagated back through untrained neural network 706. In at least one embodiment, training framework 704 adjusts weights that control untrained neural network 706. In at least one embodiment, training framework 704 includes tools to monitor how well untrained neural network 706 is converging towards a model, such as trained neural network 708, suitable to generating correct answers, such as in result 714, based on known input data, such as new data 712. In at least one embodiment, training framework 704 trains untrained neural network 706 repeatedly while adjust weights to refine an output of untrained neural network 706 using a loss function and adjustment algorithm, such as stochastic gradient descent. In at least one embodiment, training framework 704 trains untrained neural network 706 until untrained neural network 706 achieves a desired accuracy. In at least one embodiment, trained neural network 708 can then be deployed to implement any number of machine learning operations.

In at least one embodiment, untrained neural network 706 is trained using unsupervised learning, wherein untrained neural network 706 attempts to train itself using unlabeled data. In at least one embodiment, unsupervised learning training dataset 702 will include input data without any associated output data or “ground truth” data. In at least one embodiment, untrained neural network 706 can learn groupings within training dataset 702 and can determine how individual inputs are related to untrained dataset 702. In at least one embodiment, unsupervised training can be used to generate a self-organizing map, which is a type of trained neural network 708 capable of performing operations useful in reducing dimensionality of new data 712. In at least one embodiment, unsupervised training can also be used to perform anomaly detection, which allows identification of data points in a new dataset 712 that deviate from normal patterns of new dataset 712.

In at least one embodiment, semi-supervised learning may be used, which is a technique in which in training dataset 702 includes a mix of labeled and unlabeled data. In at least one embodiment, training framework 704 may be used to perform incremental learning, such as through transferred learning techniques. In at least one embodiment, incremental learning enables trained neural network 708 to adapt to new data 712 without forgetting knowledge instilled within network during initial training.

### Data Center

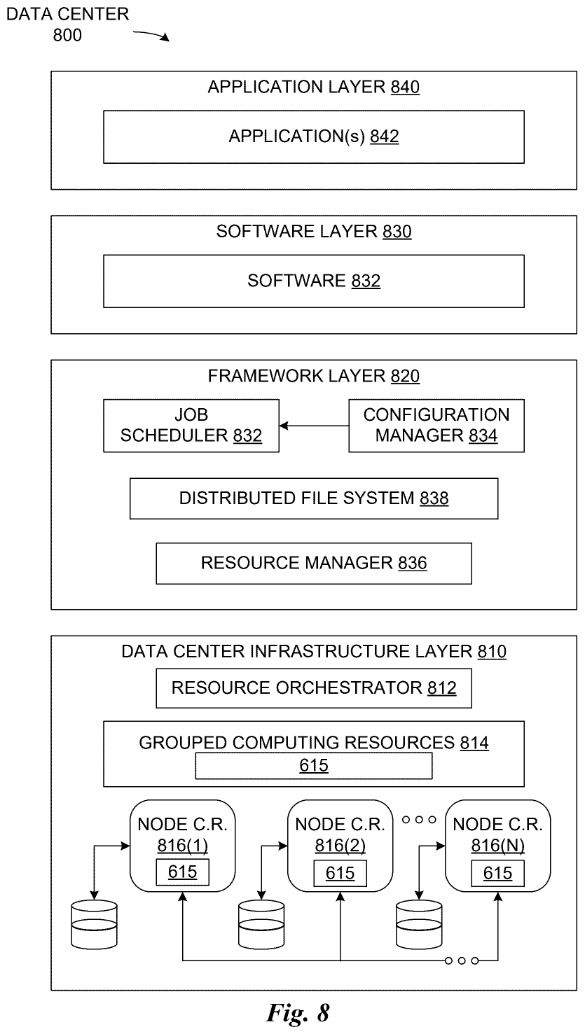

FIG. 8 illustrates an example data center 800, in which at least one embodiment may be used. In at least one embodiment, data center 800 includes a data center infrastructure layer 810, a framework layer 820, a software layer 830 and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 822 may configure or otherwise control one or more node C.R.s 816(1)-816(N) and/or grouped computing resources 814. In at least one embodiment, resource orchestrator 822 may include a software design infrastructure (“SDI”) management entity for data center 800. In at least one embodiment, resource orchestrator may include hardware, software or some combination thereof.

In at least one embodiment, as shown in FIG. 8, framework layer 820 includes a job scheduler 832, a configuration manager 834, a resource manager 836 and a distributed file system 838. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 832 may include a Spark driver to facilitate scheduling of workloads supported by various layers of data center 800. In at least one embodiment, configuration manager 834 may be capable of configuring different layers such as software layer 830 and framework layer 820 including Spark and distributed file system 838 for supporting large-scale data processing. In at least one embodiment, resource manager 836 may be capable of managing clustered or grouped computing resources mapped to or allocated for support of distributed file system 838 and job scheduler 832. In at least one embodiment, clustered or grouped computing resources may include grouped computing resource 814 at data center infrastructure layer 810. In at least one embodiment, resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 8 for inferencing or predicting operations based, at least in part, on weight parameters calculated using neural network training operations, neural network functions and/or architectures, or neural network use cases described herein.

As described herein with reference to FIGS. 1-5, a method, computer readable medium, and system are disclosed for using a diffusion model to generate a 2D image of a scene from a scene representation comprised of 3D blobs. The diffusion model may be stored (partially or wholly) in one or both of data storage 601 and 605 in inference and/or training logic 615 as depicted in FIGS. 6A and 6B. Training and deployment of the diffusion model may be performed as depicted in FIG. 7 and described herein. Distribution of the diffusion model may be performed using one or more servers in a data center 800 as depicted in FIG. 8 and described herein.

What is claimed is:

1. A method, comprising:
at a device:
processing an input that includes one or more three-dimensional (3D) blobs each representing an object in a scene and each having a corresponding text description of the object, using a diffusion model, to generate a two-dimensional (2D) image of the scene; and
outputting the 2D image of the scene.

2. The method of claim 1, wherein the one or more 3D blobs collectively represent a layout of the scene.

3. The method of claim 1, wherein each of the one or more 3D blobs defines one or more parameters of the object represented by the 3D blob.

4. The method of claim 3, wherein the one or more parameters include a size of the object in the scene.

5. The method of claim 3, wherein the one or more parameters include an orientation of the object in the scene.

6. The method of claim 1, wherein the text description of the object is a text that describes an appearance of the object in the scene.

7. The method of claim 1, wherein processing the input includes:
projecting the one or more 3D blobs into 2D to generate one or more 2D blobs each representing an object in the scene and having the corresponding text description of the object, and
processing the one or more 2D blobs with the corresponding text description, by the diffusion model, to generate the 2D image of the scene.

8. The method of claim 7, wherein the 3D blobs are projected into 2D based on an input camera pose and camera intrinsics parameters.

9. The method of claim 8, wherein the 2D image of the scene corresponds to a viewpoint of the scene from the camera pose.

10. The method of claim 7, wherein the diffusion model processes the one or more 2D blobs together with an input depth map, to generate the 2D image of the scene.

11. The method of claim of claim 7, wherein the diffusion model processes the one or more 2D blobs together with one or more other 2D images of the scene previously generated by the diffusion model from the one or more 2D blobs, to generate the 2D image of the scene.

12. The method of claim of claim 11, wherein the diffusion model processes the one or more 2D blobs together with all 2D images of the scene previously generated by the diffusion model from the one or more 2D blobs, to generate the 2D image of the scene.

13. The method of claim of claim 1, wherein the diffusion model is a text-to-image generative diffusion model.

14. The method of claim of claim 1, further comprising, at the device:
repeating the processing at least one additional time to generate at least one additional 2D image capturing a different viewpoint of the scene.

15. The method of claim of claim 1, wherein the text description of the object guides a visual appearance of the object in the 2D image of the scene.

16. The method of claim 15, wherein the visual appearance of the object in the 2D image is customizable by modifying the text description of the object.

17. The method of claim 1, wherein the method is performed online.

18. The method of claim 17, wherein the 2D image of the scene is output to a downstream application.

19. The method of claim 18, wherein the downstream application is a video game.

20. The method of claim 18, wherein the downstream application is a virtual reality application.

21. The method of claim 18, wherein the downstream application is an augmented reality application.

22. A system, comprising:
a non-transitory memory storage comprising instructions; and
one or more processors in communication with the memory, wherein the one or more processors execute the instructions to:
process an input that includes one or more three-dimensional (3D) blobs each representing an object in a scene and each having a corresponding text description of the object, using a diffusion model, to generate a two-dimensional (2D) image of the scene; and
output the 2D image of the scene.

23. A non-transitory computer-readable media storing computer instructions which when executed by one or more processors of a device cause the device to:
process an input that includes one or more three-dimensional (3D) blobs each representing an object in a scene and each having a corresponding text description of the object, using a diffusion model, to generate a two-dimensional (2D) image of the scene; and
output the 2D image of the scene.

24. A method, comprising:
at a device:
generating a dataset of three-dimensional (3D) scene representations each comprised of one or more 3D blobs that each represent an object in a scene and that each have a corresponding text description of the object; and
training a diffusion model, using the dataset, to generate two-dimensional (2D) images of scenes from input 3D scene representations comprised of object-level 3D blobs and corresponding object-level text descriptions.

25. The method of claim 24, wherein generating the dataset of 3D scene representations includes generating each of the 3D scene representations from a respective sequence of posed images.

26. The method of claim 25, wherein the posed images include color information and depth information.

27. The method of claim 26, wherein the posed images are four-channel images.

28. The method of claim 25, wherein generating the dataset of 3D scene representations includes, for each of the 3D scene representations:
semantically mapping the posed images to obtain a 3D point cloud segmentation.

29. The method of claim 28, wherein the semantic mapping includes unprojecting open-vocabulary 2D image segmentations into 3D.

30. The method of claim 28, wherein generating the dataset of 3D scene representations includes, for each of the 3D scene representations:
generating the one or more 3D blobs from the 3D point cloud segmentation.

31. The method of claim 30, wherein the one or more 3D blobs are generated from the 3D point cloud segmentation by applying spectral clustering on a distance matrix of the 3D point cloud segmentation to fuse segmentations into the one or more 3D blobs.

32. The method of claim 31, wherein the distance matrix includes distances that are each a weighted combination of geometric distance and semantic distance in a Contrastive Language-Image Pre-Training (CLIP) model.

33. The method of claim 24, wherein generating the dataset of 3D scene representations includes, for each of the 3D scene representations:
generating the text description for each of the one or more 3D blobs.

34. The method of claim 33, wherein the text description for each of the one or more 3D blobs is generated by:
projecting the 3D blob onto a plurality of posed 2D views to obtain a plurality of object masks,
selecting one of the posed 2D views resulting in one of the plurality of object masks having a largest mask area,
processing the selected posed 2D view, by a vision-language model, to generate the text description for the 3D blob.

35. The method of claim 24, wherein training the diffusion model, using the dataset, includes:
in a first training stage, fine-tuning attention layers for 2D blob guidance from a pretrained blob-grounded text-to-image diffusion model, and
in a second training stage:
configuring a first convolutional layer of the fine-tuned diffusion model to take as conditioning input both inpainting and one or more prior generated and scene-specific 2D images,
adding to the fine-tuned diffusion model a control layer for accepting depth map guidance, and
training the first convolutional layer and the control layer with the attention layers fine-tuned in the first training stage.

36. The method of claim 25, wherein a control backbone of the pretrained blob-grounded text-to-image diffusion model is frozen during the first training stage and the second training stage.

37. The method of claim 24, wherein each of the 3D scene representations is generated from a respective sequence of posed images, and wherein the diffusion model is trained on pairs of images from the sequence of posed images.

38. The method of claim 37, wherein the diffusion model is trained on the pairs of images from the sequence of posed images, including:
given a queried image from the sequence of posed images, randomly sample a source image from the sequence of posed images that has overlapping regions with the queried image,
using the source image to obtain prior images from the sequence of posed images and an inpainting mask,
computing a loss between predicted and ground truth noise over a data distribution, wherein the loss is computed as a function of the prior images and the inpainting mask.

39. The method of claim 24, further comprising, at the device:
deploying the trained diffusion model for use by a downstream application to generate the 2D images.
